(19) United States
(12) Patent Application Publication
(10) Pub. No.: US 2018/0174455 A1
(43) Pub. Date: Jun. 21, 2018

(54) ELECTRONIC DEVICE FOR CONTROLLING AND REGULATING PARKING SPACES

(71) Applicant: Enrique MIRASOL GIEB, Granada (ES)

(72) Inventor: Enrique MIRASOL GIEB, Granada (ES)

(21) Appl. No.: 15/549,982

(22) PCT Filed: Feb. 4, 2016
(86) PCT No.: PCT/ES2016/070062

§ 371 Date: Aug. 9, 2017

(30) Foreign Application Priority Data
Feb. 4, 2015 (ES) P201530140

(51) Int. Cl. G08G 1/14; G07B 15/02; G07F 17/24

(52) U.S. Cl. CPC G08G 1/148; G07B 15/02; G07F 17/246; G08G 1/147; G08G 1/146

(57) ABSTRACT

The invention relates to an electronic device for controlling and regulating parking spaces, applicable in car parks with ticket-dispensing turrets (2), comprising occupation-detecting sensors (12) in each of the parking spaces (4) and a group of ticket-dispensing turrets (2) distributed over the zone (3), each turret (2) being provided with, in addition to means for said ticket dispensing, an electronic circuit (13) connected to the sensors (12) and electronic means for sending data signals (6) about the activation of the sensors (12) and the dispensing to a microprocessor (7) incorporated in a main turret (2′), which collects the data and processes it to determine the number of spaces available. The main turret (2′) comprises data transmission means (8) for transmitting data to an Internet server (9) which provides access to the processed information through the Internet network (10).

### OBJECT OF THE INVENTION

As expressed in the title of the present specification, the invention relates to an electronic device for controlling and regulating parking spaces, which has a series of advantages and novel features that entail a significant improvement in the current state of the art and will be explained more in detail below.

More particularly, the object of the invention relates to a device which is essentially made up of a group of ticket-dispensing turrets distributed over a time-limited paid parking zone for vehicles which are linked to a microprocessor incorporated in one of the turrets collecting data from the turrets and processing it, this microprocessor furthermore being in wireless communication, for example by radiofrequency, with occupation detectors installed in the parking spaces, allowing the system to know in real time which spaces are occupied and allowing the users to know, through the Internet, the availability of said spaces in said zone, as well as allowing the surveillance personnel to know the location of any inappropriate occupation of the spaces.

### Field of Application of the Invention

The field of application of the present invention is comprised in the sector of the industry intended for vehicle parking control system installation.

### Background of the Invention

In reference to the current state of the art, it should be pointed out that although different control systems for controlling time-limited parking lots are known in the state of the art, some of which are capable of connecting with Internet applications, the existence of a system having technical, structural and constitutive features similar to those presented specifically in the system that is proposed and claimed herein is unknown, at least for the applicant.

In said sense, it should be pointed out that generally time-limited parking zones for parking vehicles, i.e., those in which the users must acquire and pay for a ticket when parking the vehicle, the payment of which depends on the time they intend to occupy the space, and place the ticket on the windshield of the vehicle so that the surveillance personnel can see that the payment has indeed been made and that the time limit indicated on said ticket is not being exceeded; zones of this type are known as blue zones or green zones and usually have a specific number of dispensing turrets distributed over the parking zone which generally only dispense one ticket after the corresponding payment is made for the chosen time.

In some cases, the turrets are furthermore suitable for connection therewith through an Internet application so that payment for the ticket can be made through a smartphone or the like.

However, unlike the present invention, none of such installations contemplates a space occupation time-based collection system with thorough, real time control of the number of spaces available as well as the location thereof in the zone in order to prevent the users from having to look for parking, and furthermore to allow surveillance personnel to know if a space is inappropriately occupied.

Additionally, it should be pointed out that the current applicant is the proprietor of patent no. ES2470990 A1 PCT/ES2013/070805 relating to a “Device for Deterring Improper Parking of Vehicles” which discloses a system which can be activated by means of a strip with sensors, said system now replaced with a system with radiofrequency antenna and/or activation, when the presence of a vehicle is detected, said sensors being connected to an electronic circuit which is in turn connected to a notification means that detects the activation of any of said sensors and consists of a device for emitting acoustic and/or light signals, or a control center to which it is connected by means of a wired or wireless communication system, and which is located in a remote location with respect to the location of said electronic circuit.

The objective of the present invention is to therefore improve said device, envisaged to prevent vehicles from parking in private driveways, on sidewalks or in other inappropriate spots, for application thereof in an electronic device the purpose of which is to provide control over free spaces for parking in a wide expanse of any urban area in which the installation thereof is contemplated, which thereby prevents wasting time and particularly fuel used up everyday by countless city dwellers who have go round and round looking for a parking space.

### BRIEF DESCRIPTION OF THE INVENTION

Specifically, the electronic device for controlling and regulating parking spaces proposed by the invention, as mentioned above, is essentially based on a group of ticket-dispensing turrets distributed over a parking zone, in which each of the parking spaces further comprises a occupation-detecting device, the turrets being provided with the electronic circuit activated by the occupation detectors, with means for said ticket dispensing as well as with means for sending data about the activation of the sensors and about the dispensing of the tickets to a microprocessor incorporated in one of the turrets, which in turn collects said data and processes it for determining, based on the occupied spaces and on the number of tickets dispensed by each turret, the number and position of the spaces available in each of the areas covered by the different turrets, allowing the users to know in real time over the Internet the availability of spaces in each of the different areas of said zone, and also allowing the surveillance personnel to know the location of any inappropriate occupation of the spaces.

Furthermore, the dispensing turrets are preferably suitable for dispensing two tickets to each user, one to be placed in view in the vehicle, with the vehicle license plate or another vehicle identification number, the time of issue, and where appropriate, the prepaid card indicator, and a second ticket for the user that must be validated in the turret itself before removing the vehicle and paying the amount depending on the time elapsed, the turrets being able to collect cash payments and to give back change, to accept payment with a credit card, prepaid card or with any other electronic means.

In any case, these turrets are furthermore provided with an electronic circuit connected either by means of a wireless system or by means of suitably protected wiring, with each and every one of the occupation-detecting sensors that will have been suitably incorporated in each of the parking spaces, for example with wireless radiofrequency cartridges buried in the pavement.

Likewise, each turret is also provided with electronic means for collecting data about the number of tickets dispensed and about the tickets paid for and time limits of each of them, and also with electronic means for continuously, and preferably wirelessly sending, through a radiofrequency signal emitting antenna or a modem, for example, both the data from the electronic circuit of the occupation-detecting sensors of the spaces and the dispensing data to the microprocessor of the turret comprising same, which is referred to herein as main turret.

This microprocessor is in turn equipped with electronic data signal receiving means for continuously collecting data from the rest of the turrets and for processing it together with its own data in order to determine if there are free spaces available, the number of free spaces and the location of each of said spaces in the area of each turret.

Furthermore, this main turret is equipped with telecommunication means for communication with an Internet server, through which the microprocessor can access the processed information with respect to the spaces available in the entire area in real time.

Additionally, the surveillance personnel of the different areas of the turrets has a terminal connected to the microprocessor of the main turret for receiving the processed data about the free spaces and occupied spaces, and for checking and verifying same in the event that the user of one of the occupied spaces has not procured the corresponding ticket.

To that end, the system is preferably programmed such that the signal of an occupied space is delayed a pre-established time, giving the user who has just placed his/her vehicle in a space the opportunity to get the corresponding ticket.

It must be indicated that the zone intended for installation of the device of the invention will preferably be, for example, an urban street area with parking spaces, such as those existing in most cities, being able to include a variable number of areas or streets with different turrets linked to a central turret which comprises the microprocessor.

Furthermore, the existence of more than one zone with the proposed parking control device in one and the same city is not ruled out, in which case the main turrets of each zone can be linked to one and the same central server to provide joint information to the users. It would be suitable for the parking zones to have no more than 200 spaces.

Likewise, the possibility of linking parking zones with turrets of the device, which will generally be above-ground parking lots, with underground parking lots associated with the system is also contemplated, for which the payment collection booths will form complementary turrets, allowing users to also know about the presence or absence of free parking spaces in said parking lots.

Therefore, in addition to the advantage entailed by knowing in real time the location of the spaces available for parking without having to go round and round to look for a space, preventing fuel consumption, and therefore CO₂ pollution in the zone, another advantage of the device of the invention is that, given that tickets are dispensed for payment thereof upon removing the vehicle, the user only makes payment for the time elapsed instead of making payment beforehand for a time expected and pre-established by the user, which is a common system in most limited parking zones of this type. Inappropriate use and misuse by occupying spaces too long are thereby prevented, and particularly frequent rotation of space occupation is enhanced, making it easier for all users to be able to use them, which is particularly relevant in areas located in the heart of most important cities and towns, given the volume of vehicles that circulate through them.

Finally, it must be pointed out that in order to further promote the rotation frequency of space occupation the described system for procuring two tickets and paying for the time used when removing the vehicle preferably contemplates increasing the cost for occupying the parking spaces depending on the time elapsed, such that the longer the time the space is occupied, the higher the hourly rate will be.

In summary, the proposed device is envisaged for application thereof specifically in parking lots in a blue zone or the like, i.e., in zones of parking spaces for vehicles, of the type contemplating dispensing turrets with printing and collection means for dispensing tickets that must be placed in view in the vehicle such that the surveillance personnel can verify the procurement of tickets and at least the time of issue thereof, with the particularity that it comprises, unlike conventional systems of said type, installing occupation detectors in each of the spaces of the car park and a group of said ticket-dispensing turrets distributed over the zone of parking spaces, which are provided with, in addition to the printing and collection means for said ticket dispensing, the electronic circuit connecting the mentioned detectors and electronic means for sending data signals about the activation of the detectors and about the dispensing of the tickets to a microprocessor which is incorporated in one of the turrets, or an also dispensing main turret, such that said microprocessor collects said data, processes it to determine the number and location of spaces available in each of the areas covered by the different turrets and transmits it to an Internet server which provides, through the network, real time access to the processed information about the spaces available in the entire area, and optionally transmits it to the surveillance personnel of the parking zone.

The described electronic device for controlling and regulating parking spaces therefore represents an innovation in structural and constitutive features unknown up until now which, combined with its practical usefulness, provides sufficient grounds for granting the exclusive right that is requested.

### DESCRIPTION OF THE DRAWINGS

To complement the description that is being made and to help better understand the features of the invention, a set of drawings is attached to the present specification as an integral part thereof in which the following has been depicted with an illustrative and non-limiting character:

FIG. 1 shows a schematic depiction of an urban zone with parking spaces in which an example of the electronic device for controlling and regulating parking spaces, object of the invention, has been implemented, where the main parts and elements it comprises, as well as the arrangement thereof, can be seen therein.

FIG. 2 shows a block diagram as a schematic depiction of a simplified example of the device according to the invention, where the main elements it comprises and the link between them can be seen.

### PREFERRED EMBODIMENT OF THE INVENTION

In view of the mentioned drawings and according to the reference numbers used, a preferred but non-limiting example of the proposed electronic device for controlling and regulating parking spaces, which comprises what is indicated and described in detail below, can be seen therein.

In this sense, as seen in said drawings, the device (1) in question comprises a group of ticket-dispensing turrets (2) distributed over a zone (3) of parking spaces (4) for vehicles, each of which spaces in turn comprises occupation-detecting sensors (12) for detecting the occupation of the said spaces.

For example, said sensors (12) are arranged in a plural number housed in a strip that is fixed to the ground in the parking space (4), in any case, each of said sensors (12) being connected by means of wiring or wirelessly to an electronic circuit (13) incorporated in the closest turret (2).

Each of said dispensing turrets (2) further comprises interactive electronic printing and collection means (5) for dispensing tickets, validating them and collecting payments depending on the time elapsed between dispensing and validation. Specifically, the turrets (2) dispense two tickets per user, one to be placed in the vehicle with at least the vehicle license plate or identification number, provided by the user, and the time of issue; and another to be validated when removing the vehicle and making payment depending on the time elapsed.

Likewise, each turret (2) is provided with electronic means for sending data signals (6) to a remote microprocessor (7), specifically data about the activation of the sensors (12) and about the number of tickets dispensed and about the validated tickets and payments collected in each of them, said data being sent continuously and preferably wirelessly to the microprocessor (7) which is installed in an also dispensing main turret (2′), i.e., likewise belonging to the group of dispensing turrets of the mentioned zone (3), and therefore, provided with an electronic circuit (13) connected to the sensors (12) of the nearby spaces (4) and with the same ticket printing and collection means.

Said microprocessor (7) is in turn linked to electronic data receiving means for continuously collecting data from the turrets (2) and for processing it together with its own data and determining in real time if there are free spaces available, the number of free spaces and in which area of which turret.

Furthermore, the microprocessor (7) is linked to processed data transmission means (8) incorporated in the main turret (2′) for sending the data to an Internet server (9) which allows, through the Internet network (10), the users to access the information about the spaces available in the entire area processed by the microprocessor.

Additionally, the surveillance personnel of the different areas of the turrets (2, 2′) has a terminal (11) which is capable of connecting to the data transmission means (8) of the main turret (2′) linked to the microprocessor (7) for directly accessing the processed information, and also preferably capable of being connected to the Internet network (10) and accessing said information provided by the server (9).

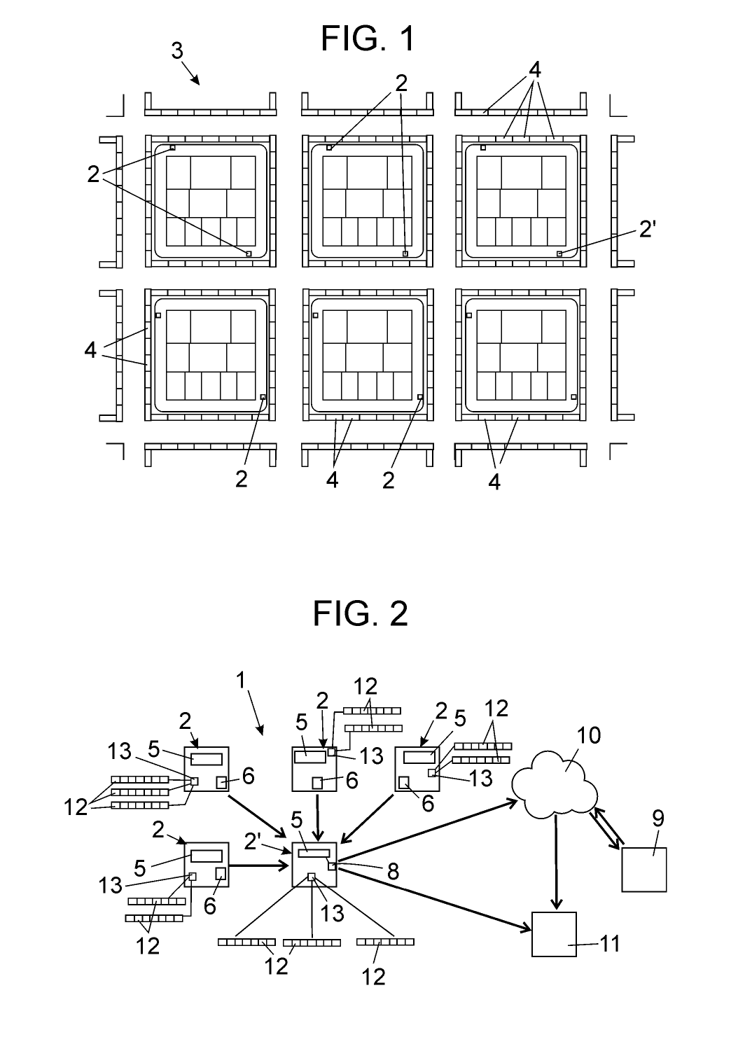

FIG. 1 depicts in a highly schematic manner a portion of a city center with several blocks of houses on the streets of which an example of the device (1) of the invention has been implemented, such that the parking spaces (4) of said streets determine the parking zone (3) covered by the group of dispensing turrets (2) distributed between the sidewalks of said streets, all of them being linked to a main turret (2′) which also works as a dispensing turret.

FIG. 2 in turn shows in a highly schematic manner and only by means of a block diagram the essential elements of the dispensing turrets (2), the relationship between the dispensing turrets (2) with sensors (12) of the spaces (4) and the main turret (2′) and the link thereof with the server (9), the Internet network (10) and the terminal (11) of the surveillance personnel, it being understood that there may naturally be a variable number of spaces linked to each turret, a variable number of turrets, taking into account in both cases the maximum distances of the communication means between the sensors (12) of the spaces (4) and the turrets (2) and between the latter and the main turret (2′); and more than one terminal (11) may also be contemplated in the event that there is more than one surveillance personnel member working at the same time in the parking zone (3) covered by the device of the invention.

Additionally, it must be pointed out that the sensors (12) will be suitably located in each space for being suitably activated when a vehicle pulls into the space, as well as for being suitably protected against possible damage caused by theft or vandalism.

Similarly, both the dispensing turrets (2) and the main turret (2′) with the microprocessor (7) are formed as dispensing machines suitably reinforced with a vandal-proof metal casing and provided with component elements, connections or power supply necessary for the operation thereof, which do not have to be described in greater detail as they are widely known on the market, including the printing and collection means (5) for feeding papers to a printer, giving out and receiving tickets and operating a coin mechanism capable of accepting cash and giving back change as well as collecting payments by means of credit cards, prepaid cards or other electronic means, furthermore having a set of buttons and/or a display for interaction purposes and for introducing the requested data, such as the vehicle license plate.

Similarly, the means for sending data signals (6) comprised in each of the turrets (2) and the processed data transmission means (8) comprised in the main turret (2′) linked to the microprocessor (7) will also be formed by the electronic components and elements normally used for such functions, preferably wireless connections by means of radiofrequency, mobile communications or an optical fiber cable.

Finally, the terminal (11) contemplated in the device as an element to allow the surveillance personnel to directly access the data of the microprocessor (7) consists of a PDA (Personal Digital Assistant)-type electronic device or a similar handheld computer.

Having sufficiently described the nature of the present invention as well as how to put it into practice, no further explanation is needed for a person skilled in the art to understand its scope and the advantages derived from it. Within its essential features, the invention may be carried out to practice in other embodiments differing in detail from the embodiment indicated by way of example, and such embodiments would also be covered by the protection granted provided that the fundamental principle thereof is not altered, changed or modified.

1. An electronic device for controlling and regulating parking spaces specifically applicable in zones (3) of parking spaces (4) for vehicles, where there are contemplated dispensing turrets (2) with interactive electronic printing and collection means (5) for dispensing tickets to be placed in view in the vehicle such that surveillance personnel can verify the procurement of tickets and at least the time of issue thereof, characterized in that it comprises at least one occupation-detecting sensor (12) in each of the parking spaces (4) and a group of ticket-dispensing turrets (2) distributed over the zone (3), each of said turrets (2) being provided with, in addition to the means for said ticket dispensing, an electronic circuit (13) connected to the sensors (12) and electronic means for sending data signals (6) about the activation of the sensors (12) and the dispensing of the tickets to a microprocessor (7) incorporated in one of the turrets, or an also dispensing main turret (2′); in that said microprocessor (7) collects said data, processes it to determine the number of spaces available in each of the areas covered by the different turrets; and in that the main turret (2′) comprises data transmission means (8) linked to the microprocessor (7) for sending the data to an Internet server (9) which provides real time access to the processed information about the spaces available in the entire zone for users through the Internet network (10).

2. The electronic device for controlling and regulating parking spaces according to claim 1, characterized in that the interactive electronic printing and collection means (5) of the turrets (2, 2′) dispense tickets, validate them and collect payment depending on the time elapsed between dispensing and validation.

3. The electronic device for controlling and regulating parking spaces according to claim 2, characterized in that the interactive electronic printing and collection means (5) of the turrets (2, 2′) dispense two tickets per user, one to be placed in the vehicle with at least the vehicle license plate or identification number provided by the user, and the time of issue, and another one to be validated when removing the vehicle and paying the amount depending on the time elapsed.

4. The electronic device for controlling and regulating parking spaces according to claim 1, characterized in that each turret (2) is provided with electronic means for sending data signals (6) to the microprocessor (7) which continuously send said data, and the microprocessor (7) is in turn linked to electronic data receiving means which also continuously collect said data, determining in real time if there are free spaces available, the number of free spaces and in which area of which turret.

5. The electronic device for controlling and regulating parking spaces according to claim 1, characterized in that it further comprises a terminal (11) for the surveillance personnel of the different areas of the turrets (2, 2′) which is capable of connecting to the data transmission means (8) of the main turret (2′) linked to the microprocessor (7) for directly accessing the processed information.

6. The electronic device for controlling and regulating parking spaces according to claim 5, characterized in that the terminal (11) for the surveillance personnel of the different areas of the turrets (2, 2′) is also capable of being connected to the Internet network (10) and accessing the information provided by the server (9).

7. The electronic device for controlling and regulating parking spaces according to claim 1, characterized in that the sensors (12) are arranged in a plural number housed in a strip that is fixed to the ground in each parking space (4).

8. The electronic device for controlling and regulating parking spaces according to claim 1, characterized in that the sensors (12) are connected by means of wiring or wirelessly to the electronic circuit (13) of the closest turret (2).
